(19) United States
(12) Patent Application Publication
(10) Pub. No.: US 2024/0366016 A1
(43) Pub. Date: Nov. 7, 2024

(54) Avocado Pit Pliers

(71) Applicant: William B. Vanbrunt, Middletown, NJ (US)

(72) Inventor: William B. Vanbrunt, Middletown, NJ (US)

(21) Appl. No.: 18/656,548

(22) Filed: May 6, 2024

Related U.S. Application Data
(60) Provisional application No. 63/464,561, filed on May 6, 2023.

(51) Int. Cl. A47J 23/00

(52) U.S. Cl. CPC A47J 23/00

(57) ABSTRACT

A tool and in particular a kitchen tool to facilitate the removal of the pit of an avocado after the avocado has been split open. The tool is in the form an avocado pit plier comprising a pair of handles each of having a hand squeezing first end and a second end distal from the first end, the second end in the form of a jaw member having an arcuate wedge-shaped portion terminating into a grip point, the pair of handles being pivotally connected with a hinge-like element which joins the pair of handles and enables the handles to be adjusted from a closed position to an opened position. The pivotally connected pair of handles can be adjustable opened such that the grip points engage the pit from both flanks of the avocado and the avocado pit is captured between the jaw members and released from an avocado.

### CROSS-REFERENCE TO RELATED APPLICATIONS

This application claims priority from U.S. Provisional Application 63/464,561, filed May 6, 2023.

### FIELD OF INVENTION

The present invention relates to a kitchen tool in the form of an avocado pit plier for safely and efficiently removing the pit from an avocado that has been split open.

### BACKGROUND OF THE INVENTION

A common method for removing an avocado pit from an avocado that has been split open is to force the blade of a knife down into the pit and twist the blade. This method causes pressure resulting in the pit to resist being twisted and removed. Other devices simply are plastic rings with sharp metal barbs or blades imbedded into the inside diameter of the plastic ring to serve as gripping points. But the metal inserts can dislodge from such devices and fall into the food being prepared. Additionally, such devices are designed with very sharp gripping points which could be dangerous to the user.

### PRIOR ART

In addition to the plastic ring devices provided with gripping points in the form of blades or metal barbs, other devices have been developed attempting to cleanly remove the pit from an avocado. For example, U.S. Pat. No. 7,421,786 to Dorion et al. discloses an avocado pitter/slicer tool having one end with such a ring having a relatively sharp and tapered edge. In U.S. Pat. No. 8,726,799 to Prommel et al., and avocado pitting device is disclosed in the form of a tool having a blade end which is designed to engage the pit of an avocado. U.S. Pat. No. 4,732,771 to Bushmann relates to a commercial apparatus for removing skins and pits from avocados. Despite the efforts of the prior art, a need still exists for a tool to remove an avocado pit from an avocado. Such a tool should be easy to use, inexpensive to manufacture and available to the average consumer.

### SUMMARY OF THE INVENTION

The present subject matter relates to a tool and in particular a kitchen tool to facilitate the removal of the pit of an avocado after the avocado has been split open. The tool in the form an avocado pit plier comprising a pair of handles each having a jaw member in the form of an arcuate wedge-shaped portion terminating into a grip point, the pair of handles being pivotally connected with a hinge element which joins the pair of handles and enables the handles to be adjusted from a closed position to an opened position.

Accordingly, it is an object of the present subject matter to provide an avocado pit plier that enables a user to remove a pit quickly and easily from an avocado that has been split open.

It is another object of the present subject matter to provide an avocado pit plier that has solid and sturdy grip points that are integral to a pair of handles.

It is an additional object of the present subject matter to provide an avocado pit plier which engages the pit from the flanks of the avocado while twisting and lifting upwardly, thereby decreasing the hold the fruit has on the pit.

It is a further object of the present subject matter to provide an avocado pit plier wherein each handle terminates at one end into a jaw member having an arcuate wedge-shaped portion terminating into a grip point, the two jaw members together forming a jaw having an adjustable jaw span to accommodate avocado pits of varying sizes and shapes.

It is yet another object of the present subject matter to provide an avocado pit plier which utilizes relatively dull and safe grip points that will not cut the skin of the user upon accidental contact as the avocado grip points do not have sharpened edges.

It is still another object of the present subject matter to provide an avocado pit plier having grip points which are pressed into the pit with hand pressure by squeezing the pair of handles together.

It is an additional object of the present subject matter to provide an avocado pit plier which securely holds and retains the pit once it is removed from the avocado until the user adjusts the handles to open the jaw members and release the pit.

It is yet a further object of the present subject matter to provide an avocado pit plier that allows the user to dislodge the pit, without the use of a sharp knife being swung toward the palm of the user's hand.

These and other objects of the present invention are accomplished by providing an avocado pit plier comprising a pair of handles each of which has a jaw member at one end with an arcuate wedge-shaped portion terminating into a grip point, the two jaw members being designed to form an adjustable jaw and a pivotally connected hinge which joins the pair handles and enables the handles to be adjusted from a closed position to an opened position.

### BRIEF DESCRIPTION OF DRAWINGS

FIG. 1 is a front perspective view of the avocado pit plier of the present subject matter.

FIG. 2 is front view of the avocado pit plier of the present subject matter adjusted to the opened position, a ruler for is provided for reference.

FIG. 3 is a front view of the avocado pit plier of the present subject matter adjusted to the closed position, a ruler being provided for reference.

### DETAILED DESCRIPTION OF THE INVENTION

The present subject matter relates to a tool and in particular a kitchen tool to facilitate the removal of the pit of an avocado after the avocado has been split open. The tool in the form an avocado pit plier comprising a pair of handles each of having a hand squeezing first end and a second end distal from the first end, the second end in the form of a jaw member having an arcuate wedge-shaped portion terminating into a grip point, the pair of handles being pivotally connected with a hinge element which joins the pair of handles and enables the handles to be adjusted from a closed position to an opened position.

In the following description, numerous specific details are set forth to clearly describe various specific embodiments disclosed herein. One skilled in the art, however, will understand that the presently claimed invention may be practiced without all the specific details discussed below. In other instances, well known features have not been described so as not to obscure the invention.

As described herein, the term “pivotally connected” shall be used to describe a mechanical arrangement wherein two or more identified objects are joined together in a manner that allows one or both objects to pivot, and/or rotate about, in relation to the other object in either a horizontal or vertical manner.

As described herein, the term “removably coupled” and derivatives thereof shall be used to describe a mechanical arrangement wherein two or more objects are joined together in a non-permanent manner, thereby allowing the same objects to be repeatedly joined and separated.

It also is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

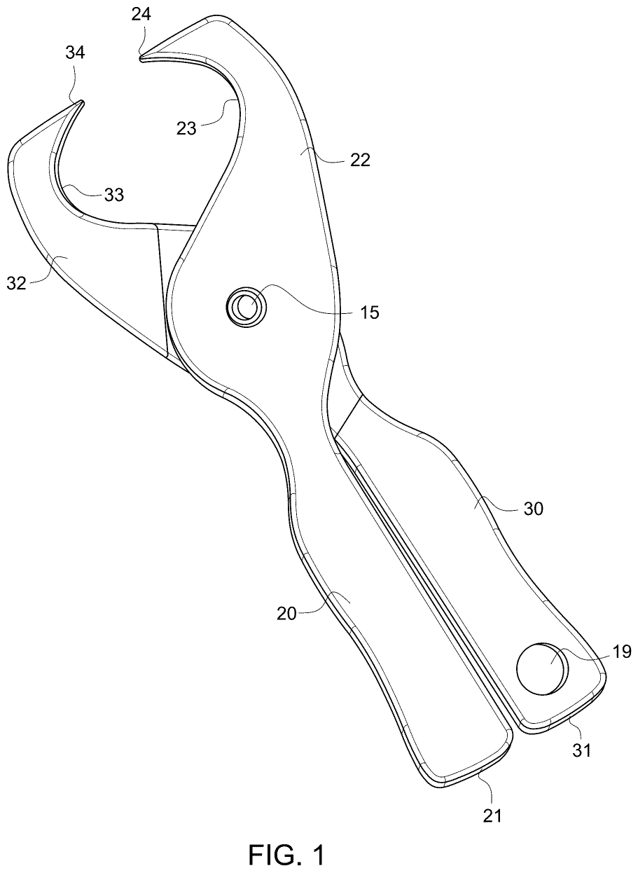

Referring now to FIG. 1, the avocado pit plier 10 of the present subject matter comprises a pair of handles 20 and 30, a hinge element 15 which pivotally connects the pair of handles 20 and 30. Handle 20 comprises a first hand-squeezing end 21 and a second jaw member end 22 distal from the first end 21, the jaw member end having an arcuate wedge shape portion 23 and terminating into a grip point 24. Similarly, handle 30 comprises a first hand-squeezing end 31 and a second jaw member end 32 distal from the first end 31, the jaw member end having an arcuate wedge shape portion 33 and terminating into a grip point 34. The arcuate wedge shape portion 23 of jaw member 22 faces the arcuate wedge shape portion 33 of jaw member 32 and the grip points 24 and 34 face each other, such that the two jaw members form an adjustable jaw which can be which can be adjusted from a fully closed position to a fully opened position by adjustably squeezing and releasing the first ends of the handles.

In operation, a user positions the avocado pit plier above the exposed pit of an avocado that has been split open and adjustably relaxes the first ends of the handles such that the opposing grip points are opened to a sufficient width to engage the pit from the flanks of the avocado. The user then squeezes the first ends together while twisting and lifting the avocado pit plier upwardly, the pit is captured in the jaw formed by the two arcuate wedge-shaped portions and is released from the avocado. In one embodiment, an aperture 19 can be disposed in one of the first ends of the pair of handles to facilitate storing the avocado pit plier on a hook when it is not being utilized.

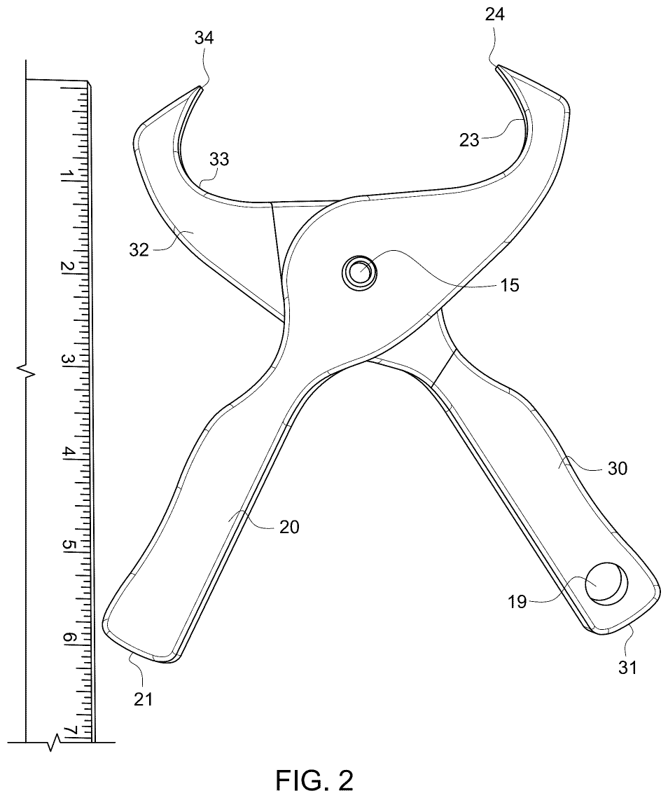

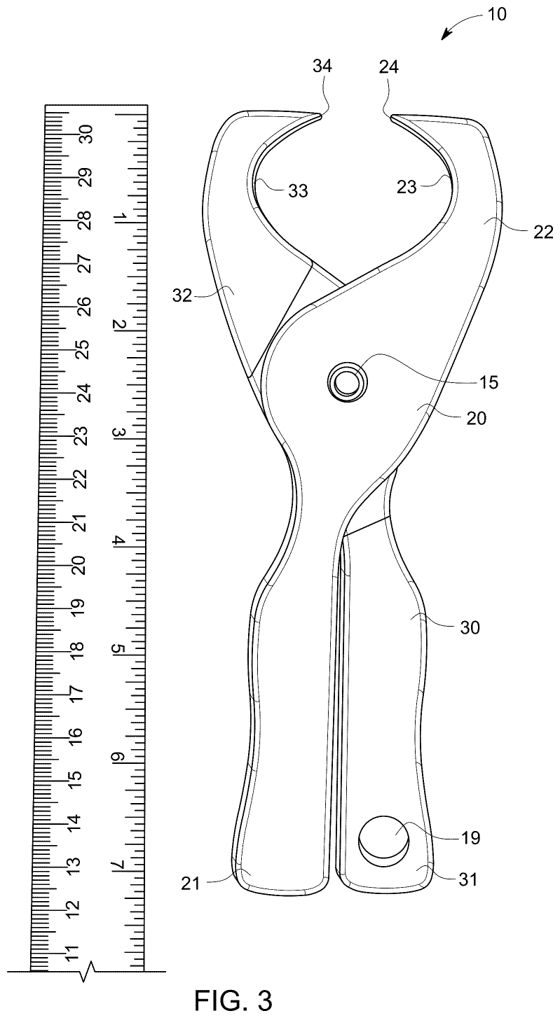

Referring now to FIG. 2 and FIG. 3, in a preferred embodiment, each handle 20 and 30 has a length of about seven (7) inches in length the avocado pit plier is 7 inches in length when it is in the closed position and about six (6) inches in length when it is in the opened position. Each of the grip points of the avocado pit plier is about one-quarter inch (0.25″) wide and disposed at about 30° from the arcuate wedge-shaped portion. The two grip points 24 and 34 are about ⅝″ apart when the avocado pit plier is in the closed position and are about three inches (3″) apart when the avocado pit plier is in the fully opened position. The two handles 20 and 30 are pivotally connected at the hinge element 15 such that the two grip points are disposed about two- and one-half inches (2.5″) distal from the hinge element 15.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

1. An avocado pit plier comprising:
a. a pair of handles, each of said handles comprising a first end and a second end distal from said first end;
b. a hinge element pivotally connecting said pair of handles; and
c. a jaw member disposed at said second end of each of said pair of handles, said jaw member having an arcuate wedge-shaped portion and terminating into a grip point,
wherein when said first ends of said pair of handles are adjustably squeezed toward each other, said avocado pit plier is in a closed position and wherein said first ends of said pair of handles are adjustably released away from each other, the space between each grip point of said jaw member is adjustably increased to a width sufficient to accommodate an exposed pit of an avocado, whereby each grip point is positioned to engage the pit from both flanks of the avocado and the avocado pit is captured between the jaw members and released from an avocado.

2. The avocado pit plier in accordance with claim 1, wherein the two jaw members together form a jaw having an adjustable jaw span to accommodate avocado pits of varying sizes and shapes.

3. The adjustable pit plier in accordance with claim 1, wherein the length of each of said pair of handles is about seven inches (7″) in said closed position and about six inches (6″) in said opened position.

4. The avocado pit plier in accordance with claim 1, wherein each of said grip points is about ⅝″ apart when the avocado pit plier is in said closed position and about three inches (3″) apart when in said opened position.

5. The avocado pit plier in accordance with claim 3, wherein each of said grip points is about ⅝″ apart when the avocado pit plier is in said closed position and about three inches (3″) apart when in said opened position.

6. The avocado pit plier in accordance with claim 1, wherein each of said grip points is disposed at about 30° from said arcuate wedge-shaped portion.

7. The avocado pit plier in accordance with claim 3, wherein each of said grip points is disposed at about 30° from said arcuate wedge-shaped portion.

8. The avocado pit plier in accordance with claim 1, wherein the length of each of said pair of handles is about seven inches (7″) in said closed position and about six inches (6″) in said opened position, each of said grip points is about ⅝″ apart when the avocado pit plier is in said closed position and about three inches (3″) apart when in said opened position and each of said grip points is disposed at about 30° from said arcuate wedge-shaped portion.

9. The avocado pit plier in accordance with claim 8, wherein the two jaw members together form a jaw having an adjustable jaw span to accommodate avocado pits of varying sizes and shapes.
